(19) United States
(12) Patent Application Publication
(10) Pub. No.: US 2008/0163312 A1
(43) Pub. Date: Jul. 3, 2008

(54) SYSTEM AND METHOD FOR PROVIDING CONTENT RELATING TO A COMMUNICATION

(75) Inventors: Dennis F. Faust, San Ramon, CA (US); Jeshua S. Borges, San Luis Obispo, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: MECA COMMUNICATIONS, INC., San Luis Obispo, CA (US)

(21) Appl. No.: 11/617,669

(22) Filed: Dec. 28, 2006

(51) Int. Cl. H04N 7/173

(52) U.S. Cl. 725/93

(57) ABSTRACT

An apparatus, system and method for presenting content relating to a context of a communication are described. A method is described for providing a content corresponding to a real time communication comprising detecting a context in the real time communication, selecting a first content relating to the context of the real time communication, and presenting the first content concurrently with the real time communication to a participant of the real time communication.

A portion of the disclosure of this application contains material that is subject to copyright protection. The copyright owner has no objection to the facsimile reproduction by anyone of this patent document or the patent disclosure, as it appears in the United States Patent and Trademark Office patent files or records, but otherwise reserves all copyright rights whatsoever.

### BACKGROUND OF THE INVENTION

1. Field of the Invention

The present invention relates generally to a system and apparatus for presenting content relating to a communication.

2. Discussion of the Related Art

Technology provides a plurality of means and methods to communicate and share information with other people. In addition to communicating face-to-face, people can communicate over long distances with a communication appliance, such as a telephone, a computer, or a push-to-talk device, for example. The communication channel may be over a wire or series of wires, or through a wireless transmission based on cellular or radio frequency systems, for example. The communication channels may be configured as a peer-to-peer system or a networked based client-server system.

The communication may be speech, text and/or an image or series of images. In some embodiments, the communication is converted from its originally generated format into an electrical signal or waveform transmission. The electrical signal and/or waveform transmission is transferred over the communication channel and converted back into a format understood by the participant of the communication.

These communication appliances may allow the communication to be half-duplex or full-duplex. The half-duplex systems typically require a participant of the communication to wait to generate and/or send his side of the communication until the co-participant has finished his generation/sending. Alternatively, the full duplex systems allow more than one participant to communicate at the same time, for example.

In some embodiments, the communication is generated by a single participant. For example, the communication may be a person composing a text document on a communication appliance, such as a personal computer (PC). The person may be typing in the text to the word document using a keyboard coupled to the communication appliance. Additionally or alternatively, the person may be entering text into a document using an apparatus configured to translate speech into text. Typically, this is done by speaking into a microphone coupled to the apparatus, wherein the apparatus comprises software configured to translate the speech.

A common method of communication is Instant Messaging (IM). IM is a form of real-time communication based on typed text or translated speech-to-text. A real time communication is one where a response to a statement or event is provided to the recipient, without request, and generally as quickly as one would receive if the communication was “really” occurring face-to-face. Although using communication devices over a communication channel brings in a slight time delay due to the transmission of the signal over the channel, this slight delay is still acceptable for a real time communication. Therefore, a real time communication includes an in-person, face-to-face communication and a communication over a communication channel, such as a cellular phone conversation, a Citizens Band (CB) Radio conversation and/or an IM text conversation.

A communication appliance may comprise a real time communication apparatus, such as an IM apparatus. In some embodiments, such real time communication apparatus' comprises a user input interface, such as a keypad or a microphone, and a means to provide the user an output, such as a display or a speaker. For example, a PC or a mobile phone may be used as a real time communication apparatus.

The IM apparatus, for example, allows a participant to type in a portion of a conversation with the user input interface, where typically, the portion of conversation is shown in text on the display for the user's verification. The user may edit the text and send that portion of the conversation to a co-participant over a network. The co-participant, having an IM apparatus, receives the portion of conversation and is displayed for him without requesting to receive or view it. The co-participant can respond to the conversation in the same manner. The real time communication apparatus, and/or input and output methods do not need to be the same for participants communicating together. However, the system they are using to communicate will format the communications as necessary to be understood by all participants.

The IM apparatus may also be used to share content, such as an image or a video file. Traditionally, if a participant of a communication wants to share content with a co-participant of the communication, he must first search sources storing the content, transfer the content to his IM apparatus, and then transfer the content to the co-participant. Alternatively, the participant may transfer the address location of the content, directing the co-participant to access the source storing the content.

The participant may implement a search engine tool to locate a piece of content or the content's address location or link. Search engines, or document retrieval systems, assist users to find documents stored on a computer system. Typically, the user searching for a document enters a key word or words into the search engine. The search engine searches an index to find possible matching documents, and returns a list of address locations or link to these documents. The user selects a document to view by clicking on the link. The search engine directs the user's computer to the server where the content is stored, and opens up the document for the user.

These types of search engines have been implemented to find, for example, public documents stored on the Internet, or the World Wide Web, or to find documents stored on the user's personal computer. For example, a user may utilize a web-browser (e.g., a software tool used to navigate through the Internet) based search engine to locate a video file on the Internet meeting a specific requirement. The user would then send the link to the video to the co-participant by copying and pasting it into the IM apparatus as a conversation text. The co-participant would then click on the link to the content, and/or copy and paste the link into a web browser, to view the content.

However, currently, no apparatus and/or method exists that presents content, relating to a real time communication, without the person generating the communication initiating a search to find the content, and then requesting the content to be presented. Currently, search engines that suggest content do not modify the selection of content based on feedback from the viewer. Additionally, search engines do not present content automatically based on detecting a context of a communication.

### SUMMARY OF THE INVENTION

Several embodiments of the invention advantageously address the needs above as well as other needs by providing a method and system for presenting content relating to a context of a communication. In some embodiments, a method for providing a content corresponding to a real time communication comprising detecting a context in the real time communication, selecting a first content relating to the context of the real time communication, and presenting the first content concurrently with the real time communication to a participant of the real time communication.

In some embodiments, the system is configured to access a source that provides content, and extract key terms from the content to use in detecting the context of a communication. In yet some further embodiments, the system indexes the content and associates the key terms with the content. And in other embodiments, the system may accept feedback from the viewer about the content that was presented, and may use this feedback to modify the index. In yet other embodiments, the system allows the viewer to share the content that was presented with other users.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a block diagram depicting an embodiment for presenting content related to a communication.

FIG. 2 is another block diagram depicting an embodiment for presenting content related to a communication.

FIG. 3 is another block diagram depicting an embodiment for presenting content related to a communication.

FIG. 4 is another block diagram depicting an embodiment for presenting content related to a communication.

FIG. 5 is an block diagram depicting an embodiment for harvesting content.

FIG. 6 is a flow diagram depicting an embodiment for harvesting content.

FIG. 7 is another block diagram depicting an embodiment for presenting content related to a communication.

FIG. 8 is a flow diagram depicting an embodiment for presenting content related to a communication.

FIG. 9 is another block diagram depicting an embodiment for presenting content related to a communication.

FIG. 10 is another flow diagram depicting an embodiment for presenting content related to a communication.

FIG. 11 is another block diagram depicting an embodiment for presenting content related to a communication.

FIG. 12 is another block diagram depicting an embodiment for presenting content related to a communication.

FIG. 13 is another block diagram depicting an embodiment for presenting content related to a communication.

FIG. 14 is another flow diagram depicting an embodiment for presenting content related to a communication.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, application specific integrated circuits (ASIC) or the like. The hardware circuits may be implemented as part of a system or platform, such as a computer configured to connect to, or network with, other systems or platforms.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present invention sets forth an apparatus, system and method for presenting content relating to a context of a communication.

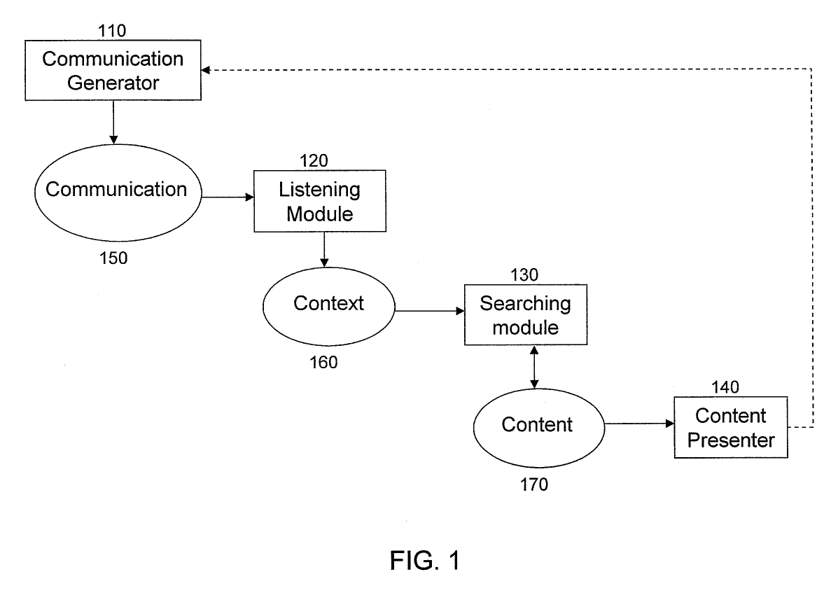

Referring to FIG. 1, shown is a listening module 120, a communication generator 110, a searching module 130, and a content presenter 140.

The communication generator 110 is coupled with the listening module 120. The listening module is coupled with the searching module 130. The searching module 130 is coupled with the content presenter 140, and in some embodiments the content presenter 140 is coupled with the communication generator 110.

Each element above is coupled through an electrical, mechanical and/or wireless communication channel, which may include a radio frequency communications channel, an optical communications channel, an infrared communications channel, or the like. Information is transferred between the modules, for example, electrically in data files via a bus, or a wireless and/or land based computer, telephone, and/or cellular network. Additionally or alternatively, the communication generator 110 may be configured to generate an audio or visual communication 150, wherein the listening module input 120 may be configured to receive the communication 150 in an audio (e.g., a microphone) or visual (e.g., a camera, or vision system) format.

The communication generator 110 is an appliance and/or person configured to generate a communication 150 that is unidirectional, bidirectional, or multidirectional, such as, text, audio, video, instant messages, or streaming media. For example, the communication generator 110 may be a person inputting data into a text document either by writing, typing or speaking into an appliance (e.g., PC, Cellular Phone, PDA, microphone.) In other embodiments, the communication generator 110 is two or more persons conversing, either in person, over a telephone, data or text message network (e.g., land based, wireless, wifi and/or through Internet), or through an instant messaging (IM) apparatus or short message apparatus. The communication generator 110 may also be a video or streaming media playing for a viewer.

The listening module 120, the searching module 130, and/or the content presenter 140 may be configured as a hardware and/or a software module. Each element may be separate from, or a part of the communication generator 110. For example, the communication generator 110 may be implemented on an appliance such as a PC, PDA, cellular phone, smart phone, or personal communications device. The listening module 120, the searching module 130, and/or the content presenter 140 may be implemented in software installed on the appliance. The elements of the present embodiment may use a portion of the hardware in the appliance, and may either be separate from or share hardware and/or software resources with the communication generator 110 and/or other elements. In other embodiments, the listening module 120, the searching module 130, and/or the content presenter 140 are implemented in an appliance separate from the communication generator 110 and the other elements.

This communication generator 110 outputs the communication 150 to the listening module 120, and the listening module 120 receives, or listens to, the communication 150 in a manner that preferably does not interrupt or otherwise disturb the communication 150 in real time, such as by delaying the communication. Thus, a person participating in the communication 150 will not perceive a difference in the communication 150 as compared to a system not implementing the present embodiment.

Additionally, as is later discussed, content is presented to the person generating, viewing and/or participating in the communication 150 without further action by that person other than generating the communication 150. This means the listening module 120 listens peripherally and/or unobtrusively to the communication 150, and the person generating or listening to the communication does not need to initiate a search for additional content. Thus, the communication generator 110 may continue generating communication as if the listening module 120 is not listening. Additionally, the listening done by the listening module is imperceptible to the communication generator 110, such as a participant of the communication. In some embodiments, the listening module 120 is configured to analyze and listen to the communication 150 while maintaining the privacy of the communication 150. In these embodiments, the communication 150 is not recorded and may not be recreated.

The listening module 120 is configured to analyze the type of communication 150 generated by the communication generator 110. For example, the listening module 120 may receive and/or analyze the communication 150 electrically in a data file as text, or audibly by listening to person speak into a microphone. Additionally or alternatively, the listening module 120 may be configured as a camera or configured to receive a video or series of images.

In some embodiments, the listening module 120 is configured to intercept and convert the communication 150 into a format or protocol recognized by the listening module 120. The communication 150 may be in a format that comprises letters, numbers, and/or symbols forming at least a word, term or phrase. These words, terms or phrases may be embedded in a software protocol understood by the communication generator 110 or receiving apparatus of the listening module. The listening module 120 may be configured to convert various types of formatted communications received from various types of communication generators into a single, universally understood, format.

The listening module 120 then analyzes to the communication 150 and detects a context 160 of the communication 150. The context 160 detected by the listening module 120 may be a word, symbol, image, or a phrase comprising multiple words, symbols and/or images, for example. The listening module 120 sends this context 160 to the searching module 130. The listening module 120 may be configured to convert the context 160 detected into a format understood by the searching module 130.

The searching module 130 is configured to receive the context 160, and if needed, may convert the context 160 sent by the listening module 120 into a format recognized by the searching module 130. This format may be a protocol implemented in search engines for finding content related to a keyword or phrase, for example. The searching module 130 is configured to search content sources, an index and/or a database (not shown), for content 170 that relates to the context 160 of the communication 150. The searching module 130 selects content 170 relating to the context 160, and sends the content 170 to the content presenter 140.

The content presenter 140 may be configured to accept and present multiple formats of content 170. The content 170, for example, may be a document, video and/or audio clip, website, book, newspaper, magazine, article and/or a hyperlink to content for example. Additionally, the content presenter 140 is configured to present the content 170 found by the searching module 130 concurrently with the communication 150.

For example, in one embodiment, the communication generator 110 generates a communication such as an IM conversation occurring between participants each using a (PC) coupled to the Internet. As the IM conversation (or the communication 150) is occurring, the listening module 120 detects a context 160 of the IM conversation. The listening module 120 sends the context 160 to the searching module 130, where a search for content 170 relating to the context 160 is initiated.

In some embodiments, the searching module 130 accesses a content source on the Internet, and finds content 170, such as a video clip or news article, that relates to the context 160. The searching module 130 retrieves this content 170 from the content source on the Internet and sends it to the content presenter 140. The content presenter 140 then presents the content 170 to at least one of the participants of the IM conversation (communication 150) while the IM conversation is occurring. Thus, the presentation of the related content is concurrent with the communication.

In one embodiment, the content 170 is a video clip, and the content presenter 140 presents the content 170 by playing the video clip for at least one of the participants of the IM conversation. Playing the video clip may include opening a viewing apparatus for the participants to view the video clip. Additionally, the viewing apparatus may provide the participant a choice to view the content 170 and share the content 170 with other people. In some embodiments, presenting the content 170 may include presenting a link to the location where the content 170 is stored. The participant can then chose to view the content 170 by clicking on the link to the content 170. These, and other, embodiments are discussed in further detail below.

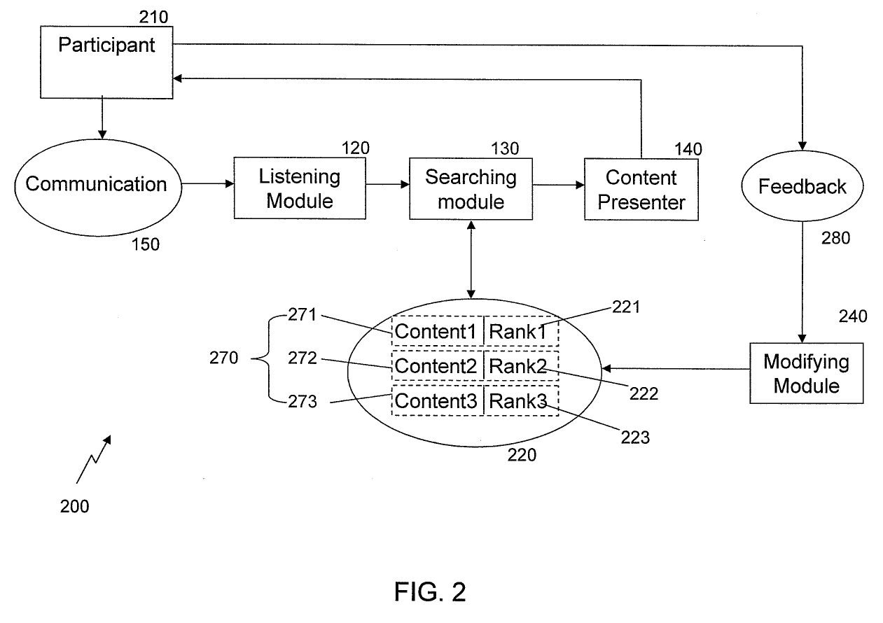

Referring to FIG. 2, shown is a participant 210, a listening module 120, a searching module 130, a content presenter 140, and an index 220, and a modifying module 240. The index 220 comprises a plurality of content 270, comprising a first, second and third content 271-273 each with a first, second and third content ranking 221, 222, 223 respectively.

In this system 200, the participant 210 is coupled the listening module 120, the content presenter 140, and the modifying module 240. The listening module 120 is coupled to the searching module 130, and the searching module 130 is coupled to the content presenter 140 and the index 220. The modifying module 240 is also coupled to the index 220. Each element is coupled through an electrical, mechanical or wireless communication channel. The communication channel may be within an appliance, over a cable connecting one or more appliances, and/or over a land based or wireless local or wide area network.

In this embodiment, a participant 210 is the generator of the communication 150. As in FIG. 1, the listening module 120 listens for a context 160 in the communication 150. After detecting a context 160, the listening module 120 sends the context 160 to the searching module 130. The searching module 130 then searches a plurality of content 270, comprising a first, second and third content 271, 272, 273, for content related to the context 160. In some embodiments, the plurality of content 270 comprising a first, second and third content 271, 272, 273 is indexed in an index 220, and the searching module 130 searches the index 220 for content relating to the context 270. In some embodiments, the first, second and third content 271, 272, 273 are each associated with a first, second and third content ranking 221, 222, 223, respectively.

The searching module 130 then retrieves the first, second and/or third content 271, 272, 273 that relates to the context 160 of the communication 150, and delivers it to the content presenter 140. The content presenter 140 is configured to display the first, second and/or third content 271, 272, 273 to the participant 210.

In some embodiments, the index 220 may store a link or an address location of where the first, second and third content 271, 272, 273 is stored. The address location of the content 270 may be the Uniform Resource Locator (URL) of a server on the Internet (discussed in further detail below). Additionally or alternatively, the index 220 may store the first, second and third content 271, 272, 273 data file. The index 220 may be accessible by the searching module 130, the content presenter 140, and/or directly by a participant 210 of the communication 150.

For example, in the case where the index 220 stores the first content 271 data file, the searching module 130 accesses the index 220 to retrieve or download the first content 271 data file, and sends the data file to the content presenter 140. In other embodiments, the searching module 130 accesses the index 220 for the stored address location of the first content 271 to send to the content presenter 140. The searching module 130 may access a remote server on the Internet to retrieve the first content 271 and send it to the content presenter 140. Alternatively, the searching module 130 may send only the address location or URL of the first content 271 to the content presenter 140. In this case, either the content presenter 140 or the participant 210 may access the content source using the URL and a web-browser to retrieve or download the first content 271 data file. The above methods are also used for accessing the second and third content 272, 273.

In some embodiments, the index 220 stores only the address location of the first content 271, however, upon indication by the searching module 130, the content presenter 140 or the participant 210, the index 220 accesses the source of the first content 271 to retrieve or download the first content 271 data file. Thereafter, the index 220 will send the first content 271 data file to at least one of the searching module 130, content presenter 140 or participant 210. In the future, the index 220 does not need to re-access the content source to download the first content 271 data file and, therefore may present the first content 271 more rapidly than the first presenting of the first content 271. The above implementations are only examples, and one skilled in the art may use other variations of configurations depending on the particular application implemented.

FIG. 2 also shows how the system 200 is configured to receive feedback 280 from the participant 210 regarding the content having been presented. The feedback 280 is subsequently used by a modifying module 240 to modify the first, second and/or third content ranking 221, 222, 223. In some embodiments, the content presenter 140 or a viewing apparatus, is configured to provide the feedback interface for the participant 210. This feedback interface is described in further detail below.

The first, second and third ranking 221, 222, 223 may comprise a plurality of elements, such as: the relatedness of the first, second or third content 271, 272, 273 to the context 160 of the communication 150, whether or not the quality of the content 270 was appreciated by the participant 210, and/or a ranking given to the content 270 by the source of the content 270. The feedback 280 provided by the participant 210 may reflect the opinion of the quality of the content, or how well the content related to the context of the communication. Therefore, the feedback 280 provided by the participant may affect one or more of the elements of the first, second and/or third content ranking 221, 222, 223. The modification of the first, second and/or third content rankings 221, 222, 223 will in turn modify the index 220 of the first, second, and third content 271, 272, 273.

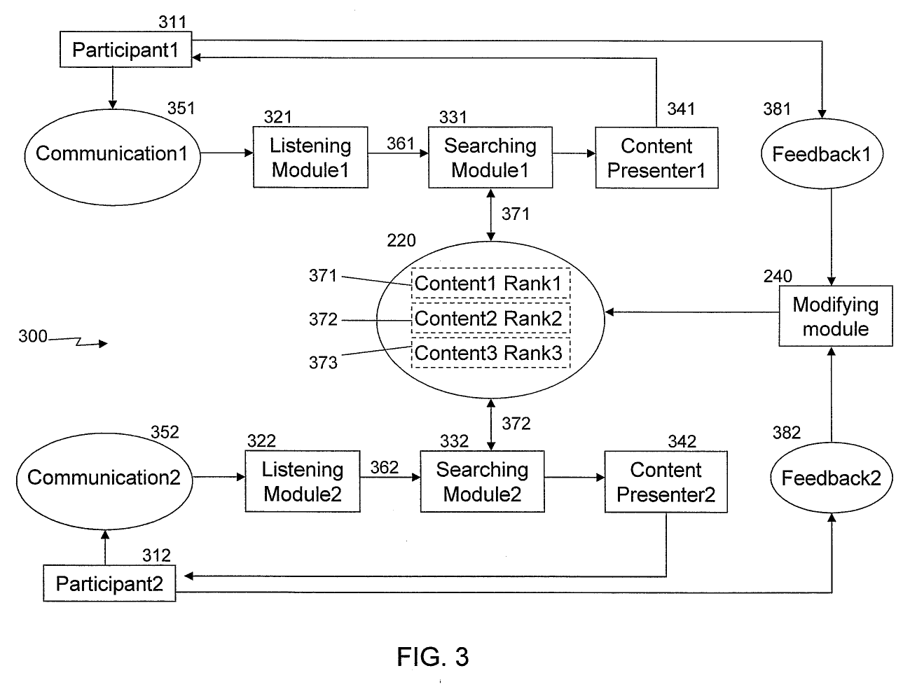

Referring next to FIG. 3, shown is a first participant 311, a second participant 312, a first and second communication 351, 352, a first and second listening module, 321, 322, a first and second searching module 331, 332, a first and second content presenter 341, 342, an index 220 and a modifying module 240. The index comprises a first, second and third content 371, 372, 373.

Similar to the embodiment described FIG. 2, the first participant 311 is coupled to the first listening module 321, the first content presenter 341 and the modifying module 240. The first searching module 331 is coupled to the first listening module 321, the index 220 and the first content presenter 341. The second participant 312 is coupled to the second listening module 322, the second content presenter 342, and the modifying module 240. The second searching module 332 is coupled to the second listening module 322, the index 220 and the second content presenter 342.

In some embodiments, the first and second searching module 331, 332 comprise a single searching module, wherein each of the first and second listening modules 321, 322 and the first and second content presenters 341, 342 are coupled to the single searching module. The elements in FIG. 3 are configured similar to those described in reference to FIGS. 1 and 2.

In this system 300, the first participant 311 generates a first communication 351, and the second participant 312 generates a second communication 352. In some embodiments, the first and second communication 351, 352 are generated independently from the other and generally at the same time. In other embodiments, the first and second communication 351, 352 are generated in response to each other and one at a time.

The first listening module 321 listens for a first context 361 of the first communication 351, and sends the first context 361 to the first searching module 331. The first searching module 331 searches the index 220 of the first, second and third ranked content 371, 372, 373. The first searching module 331 may select one or more of the first, second or third ranked content 371, 372, 373 to present, or alternatively, in some embodiments, selects the highest ranked content in the index 220.

For example, the first searching module 331 determines that the first, second and third ranked content 371, 372, 373 all relate to the first context 361 of the communication 351. However, the first searching module 331 selects the first ranked content 371 to present because it relates to the first context 361 of the communication 351, and because it is ranked the highest out of all relating content. This first ranked content 371 is sent to the first content presenter 341 for presentation to the first participant 311.

The first participant 3 1 may then provide a first feedback 381 about the first ranked content 371. Once the modifying module 240 receives the first feedback 381, the modifying module 240 modifies the ranking of the first ranked content 371. In some embodiments, the first feedback 381 is negative if the first participant 311 decides the first ranked content 371 did not relate to the first context 361. Additionally or alternatively, the first feedback 381 may also reflect a positive or negative opinion of the quality of the first ranked content 371. Various types of feedback are discussed in further detail below.

After the modifying module 240 modifies the ranking of the first ranked content 371, a second participant 312 generates a second communication 352. The second listening module 322 detects a second context 362 and sends it to the second searching module 332. The second searching module 332 selects a second ranked content 372 from the index 220 and sends it to the second content presenter 342 for presentation to the second participant 312. The second participant 312 may then provide a second feedback 382 about the second ranked content 372. The modifying module 240 modifies the ranking of the second ranked content 372 according to the second feedback 382.

In some embodiments, modifying the index 220 according to the first and second feedback 381, 382 influences which content is presented to either one, or both, of the first and second participant 311, 312 in future communications. For example, the first participant 311 is presented the first ranked content 371 and provides a first feedback 381 about the first ranked content 371. The first feedback 381 indicates that the first ranked content 371 does not relate to the first context 361. The modifying module 240 then modifies the ranking of the first ranked content 371 to reflect this first feedback 381.

After the modification, the second participant 312 generates a second communication 352 with a second context 362 analogous to the first context 361. Without the modification described above, the first ranked content 371 would be selected for being related to the second context 362 because of its similarity to the first context 361. However, in this example, the modification of the index 220 based on the negative first feedback 381 causes the first ranked content 371 to be ranked below the second and/or third ranked content 372, 373. Therefore, instead of selecting the first ranked content 371, the second searching module 332 will select the second and/or third ranked content 372, 373 before selecting the first content 371. In an embodiment where only the highest ranked content is selected, the second searching module 332 only selects the second ranked content 372 for presentation.

In another example, where the second context 362 is different from the first context 361, the second searching module 332 may still select the first content 371. This is provided that the system 300 finds the first ranked content 371 still relates to the second context 362, even in light of the modifications described above. In some embodiments, this means that the negative first feedback 381 dealt with how well the first ranked content 371 related to the first context 361 instead of the quality of the content. Therefore, it is still possible that the first ranked content 371 relates to the second context 362.

However, if the first feedback 381 from the first participant 311 deals with the quality of the first content 371, and even though the second context 362 and the first content 371 are related, it is still possible the first ranked content 371 to not be selected after the modification of the index 220. This may be the case when the modification puts the first ranked content 371 below the third ranked content 373, and both relate to the second context 362. In this case, the third ranked content 373 will be selected by the second searching module 332 for presentation to the second participant 312.

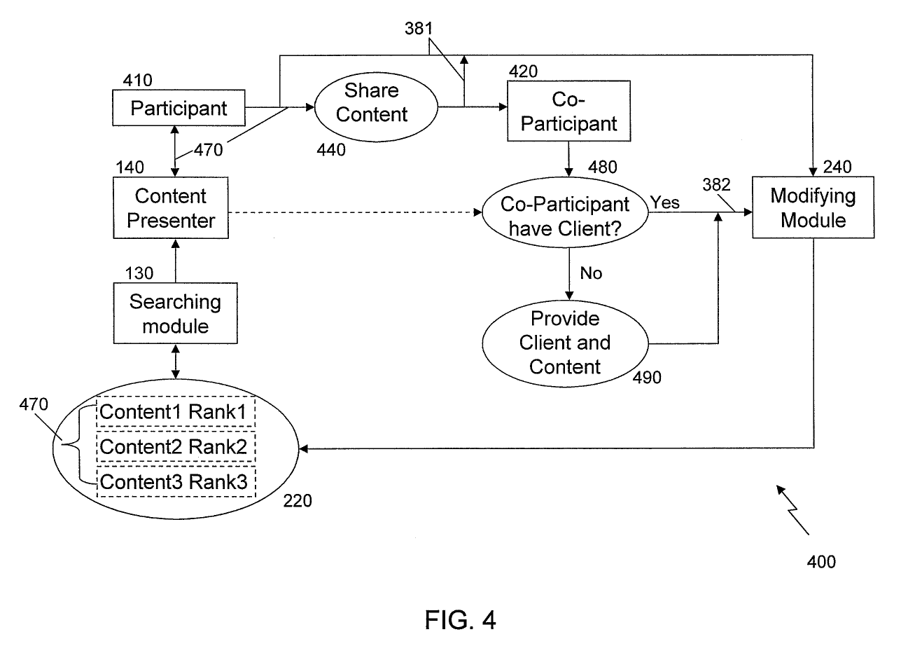

Referring next to FIG. 4, shown is a participant 410, a co-participant 420, a searching module 130, a content presenter 140, an index 220 comprising ranked content 470, and a modifying module 240.

The system 400 is configured similar to that described in reference to FIGS. 1-3. In some embodiments, the participant 410 and the co-participant 420 are generating a communication 150 together (i.e. having a conversation), each with a separate communication appliance. The participant 410 and co-participant 420 are coupled together, for example, either directly, through a peer-to-peer connection, through a client-server network, and over a wireless, land based and/or cellular network. In other embodiments, the participant and co-participant are communicating face-to-face with a listening module 120 (not shown) listening to the communication 150.

In this embodiment, the content presenter 140 is coupled to the participant 410 and is configured to present ranked content 470 to the participant 410. The content presenter 140 is further coupled to the co-participant through the connection between the participant 410 and the co-participant. The content presenter 140 is also configured to present ranked content 470 to the co-participant 420 upon request by the participant 410.

Each communication appliance configured with a client to view the ranked content 470 (described in further detail below), is configured to send feedback to the modifying module 240. In this embodiment, the participant 410 is configured with the client, and therefore is in communication with the modifying module 240. The co-participant 420, in some embodiments, is not initially configured with the client. However, upon installation of the client, the co-participant will also be configured to communication with, and send feedback to, the modifying module 240.

For example, a listening module (not shown) detects a context of the communication 150 generated by the participant and co-participant. The searching module 130 searches for content related to the context, and sends the content presenter 140 the selected ranked content 470. The content presenter 140 then presents the selected ranked content 470 to the participant 410.

After viewing the selected ranked content 470 having been presented, the participant may provide a first feedback 381 to the modifying module 240. The participant 410 may also initiate the sharing 440 of the ranked content 470 with the co-participant 420. In order to share 440 the ranked content 470, the content presenter 140 determines if the co-participant 420 has the proper client 430, or viewing apparatus, to view the ranked content 470. If the co-participant does have the proper client 430 to view the ranked content 470, then the ranked content 470 is presented to the co-participant 420. If the co-participant does not have the proper client 430, then the content presenter 140, for example, will provide 480 the client to the co-participant 420.

Thereafter, the co-participant 420 can view the ranked content 470 and may provide a second feedback 382 to the modifying module. In some embodiments, the act of the participant 410 sharing 440 the ranked content 470 with a co-participant 420 is considered positive feedback of the ranked content 470 that was presented, and is sent as a first feedback 381 to the modifying module. The modifying module 240 will then use both the first and second feedback 381, 382 from the participant 410 and the co-participant 420 to modify the rankings of the ranked content 470 in the index 220, similar to the method described above in reference to FIGS. 2-3. Additionally, in some embodiments, the client provided to the co-participant 420 comprises a listening module and a content provider. This functionality allows the system 400 to listen to other communications generated by the co-participant 420 in order to present ranked content 470 relevant to future communications.

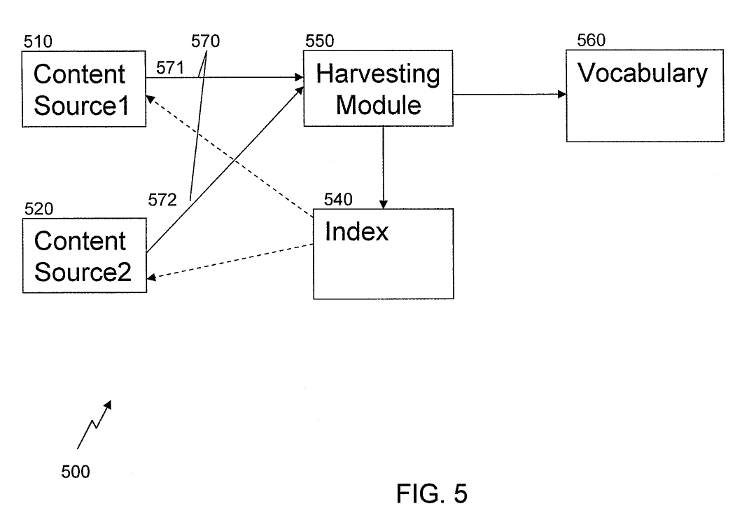

Referring next to FIG. 5, shown is a first and second content source 510, 520, a harvesting module 550, a vocabulary 560, and an index 540.

In this system 500, a harvesting module 550 is in communication with a first and second content source 510, 520, a vocabulary 560 and an index 540. In some embodiments, the index 540 is also in communication with the first and second content source 510, 520. The harvesting module 550 may be implemented through software, hardware, or a combination of software and hardware. The harvesting module 550 may be located on a server, a personal computer, or any appliance configured to access the first and/or second content source 510, 520. Although multiple content sources are shown, only a single content source is necessary for implementation. Furthermore, the first and second and content source 510, 520 need not be remote from the harvesting module 550 or the index 540, and all may be implemented on the same appliance.

The first and second content source 510, 520 are appliances configured to store content 570, such as, a server, a personal computer, or an external data storage device, for example. The index 540 is an appliance configured to store an index or table of information, such as, a database. The index 540, in some embodiments comprises storage space to store content data files, and is accessible and searchable by, for example, the harvesting module 550 and/or a searching module (not shown). The index 540 may also be implemented on the same appliance as the harvesting module 550 and/or the searching module.

The vocabulary 560 is configured to store characters and/or numbers that form words, terms or phrases. The vocabulary 560 may be a storage device or, for example, a data file, that is configured to be updated by the harvesting module 550.

The harvesting module 550 is configured to collect content 570 for systems such as those described in reference to FIGS. 1-4. The harvesting module 550 accesses the first and second content source 510, 520, and stores either a link or an address location to the content 570, and/or the content 570 data file in the index 540. For example, in some embodiments, the harvesting module 550 accesses the first content source 510 and retrieves a first content 571 data file. The harvesting module 550 then transfers the first content 571 data file to the index 540 for storing. In other embodiments, the harvesting module 550 accesses the first content source 510 and retrieves the address location or URL of the first content 571. The harvesting module 550 then accesses the index 540, and stores the address location of the first content 571 in the index 540.

The first and second content source 510, 520 may be remote servers storing independently produced content. They may be sources such as YouTube™, Google™ Video Search, iFilm™, My Space™. YouTube™, for example, is a server accessible on the internet, where a person stores content, such as video and/or image files, for others or the public to access and view the content. Another example of a content source is a storage device (e.g. a hard drive) installed either internally or externally to a personal computer where previously produced text, video, picture, and/or audio files are stored.

The address locations of the content 570 typically have a tag, or a file name, associated with the content 570. These names are provided by the first and/or second content source 510, 520, and may comprise a plurality of characters, words, terms or phrases. The harvesting module 550 is configured to analyze the tags of the content and extract some or all of the characters, words, terms and/or phrases within the tags to build a vocabulary 560 of key terms or phrases. In some embodiments, the harvesting module 550 interprets, edits, and/or adds to the tags associated with the content 570 and stores the content 570 and edited tags together in the index 540 and/or vocabulary 560. The harvesting module 550 may also include the original tag and other alternative terms or phrases corresponding to the content 570 in the index 540.

The tags may use new words, new spellings of words, or new definitions of words that are uncommon in the English language. These new words, spellings and definitions represent the Zeitgeist or “feeling of the times”. Therefore, by building the vocabulary 560 with these tags, the listening module 120 (in FIG. 1) recognizes these new words, spellings and definitions that would otherwise not be recognized in a communication 150. This is helpful in presenting content that best relates to the discussion 1024 occurring, or the context, of the first communication 151, and is therefore more meaningful and timely to the user.

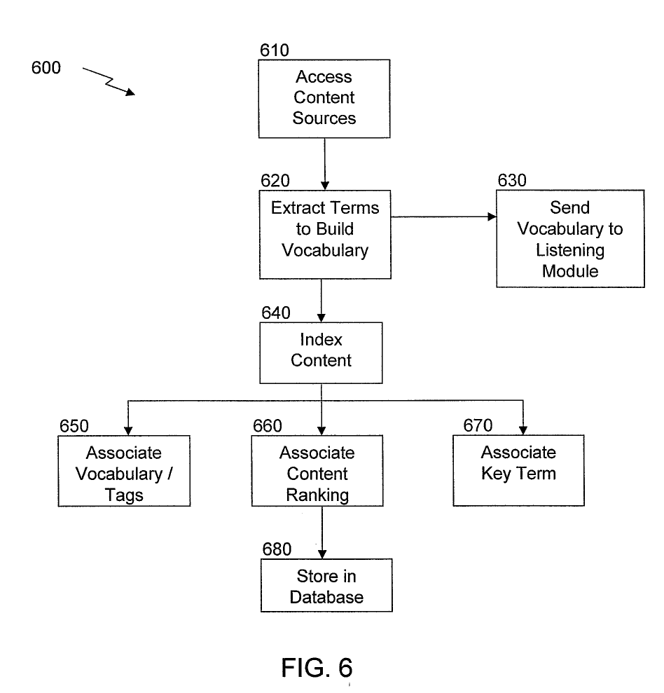

Referring next to FIG. 6, shown is an operation of the system 500 in FIG. 5. The content harvesting process 600 begins with the harvesting module 550 in FIG. 5 accessing 610 a first content source 510 for a first content 571. Next, the harvesting module 550 extracts 620 terms from the first content 571 to build a vocabulary 560. The terms, for example, may be extracted 620 from the tags of the first content 571, as discussed above, and/or additionally, the terms may be extracted 620 from the first content 571. The harvesting module 550 may analyze the first content 571 data file (e.g., a text document) for a first key term occurring within in the document, and use the first key term to build the vocabulary 560. Additionally, the harvesting module 550 may analyze a video or audio content file for terms, phrases or images to build the vocabulary 560. Once built, and/or after having been updated, the vocabulary 560 is then sent 630 to a listening module 120 for use in detecting the context 160 of a communication 150, as discussed in reference to FIGS. 1-4 above.

Next, the indexing 640, in an index 540, of the first content 571 ensues. As discussed above in reference to FIG. 5, the index 540 may comprise a plurality of elements such as a link, address location or some other identification of the first content 571. Additionally or alternatively, the index 540 may comprise the first content 571 data file.

In some embodiments, the indexing 640 the first content 571 includes associating 650 a first key term or a first list of vocabulary and/or tags that comprise terms, phrases, images or characters related to the first content 571. The indexing 640 the first content 571 may also include associating 660 a first content ranking 221 with the first content 571. The first content ranking 221, in some embodiments, comprises a ranking associated with the first content 571 by the first content source 510. For example, YouTube™ maintains a ranking system for the content stored or indexed on its servers. The ranking system corresponds to how many people view the content and/or how often the content is viewed. This type of ranking may be incorporated into the first, second, and third content rankings 221, 222, 223 of the first, second, and third content 271, 272, 273 as described in reference to FIG. 2.

Furthermore, as described in reference to FIG. 4, the indexing may include associating 670 a first key term with the first content 571. Additionally, the index 540 may associate a first key term ranking with the first key term having been associated to the first content 571. In some embodiments, this index 540 of information is stored 680 in a database accessible by a modifying module (not shown).

In some embodiments, accessing 610 the first content source 510 includes the harvesting module 550 navigating to a first content source 510, such as Youtube.com™. The harvesting module 550 follows all content links from a first content 571, to a second content 572, and so on. While following each link, the harvesting module 550 records each of the first and second content 571, 572 , the first and second content source's 510, 520 URL, and other additional corresponding information to the index 540. Once all content linked to the first content 571 is exhausted, the harvesting module 550 returns to the home page of the first content source 510 and the process is started over again with a third content. Additionally or alternatively, the harvesting module 550 navigates to a second content source 520, and repeats the same process. This content harvesting process 600 may occur periodically, such as multiple times a day or a week. Alternatively, the content harvesting process 600 may occur asynchronously, or by initiation of a system administrator.

Once the first content 571 is recorded, or as it is being recorded, the harvesting module 550 extracts information from the first content source 510 to populate aspects of the index 540 as discussed above. The harvesting module 550, in some embodiments, is configured to return to the first content source 510 and retrieve new information regarding the first content 571 to update the index 540. This type of updating may occur overnight or every hour depending on the application.

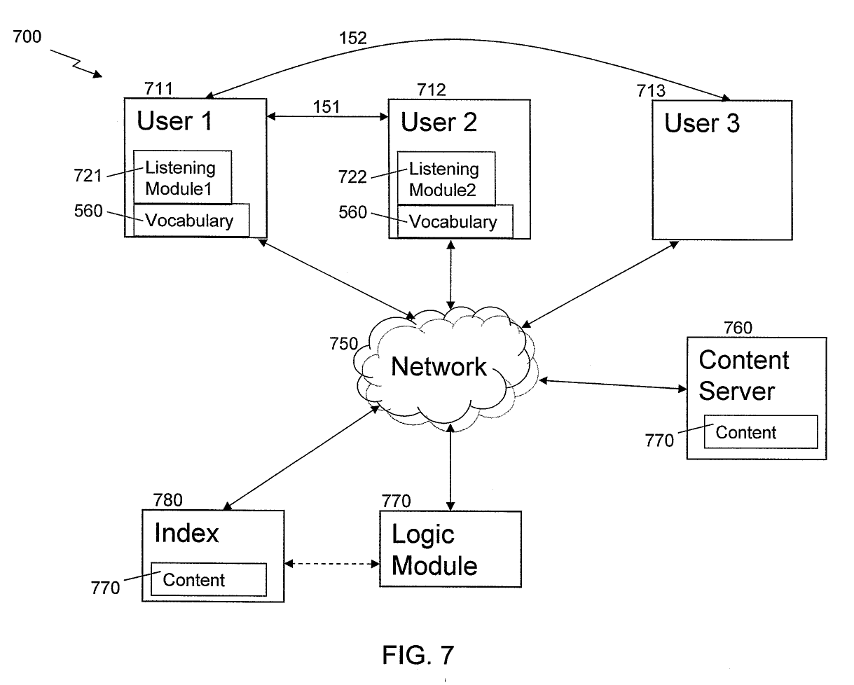

Referring next to FIG. 7, shown is a first, second and third user 711, 712, 713, a network 750, a content server 760, an index 780 and a logic module 770. The first and second user 711, 712 each comprise a first and second listening module 721, 722 respectively, and a vocabulary 560. The index 780 and the content server 760 further comprise content 770.

FIG. 7 shows the first, second and third user 711, 712, 713, in communication with one or more other users through a network 750, such as, the Internet. The content server 760, the logic module 770 and the index 780 are also in communication with the network 750. In some embodiments, the logic module 770 is also directly coupled to the index 780. Each first and second user 711, 712 and corresponding first and second listening module 721, 722 have access to the vocabulary 560 built by the harvesting module 550 as described in reference to FIG. 5.

In one embodiment, the first user 711 generates a first communication 151 with the second user 712. This first communication 151, for example, is a text IM conversation between the first and second user 711, 712, and is occurring in real time over the network 750. The first listening module 721 listens to the first communication 151 for a context of the first communication 151. For example, the first listening module 721 compares the characters, words and terms in the vocabulary 560 to the terms used in the first communication 151.

In some embodiments, the listening and detecting are imperceptible to the first and second user 711, 712. And yet in further embodiments, the listening for and detecting of a context does not involve recording the first communication 151. Thus, the first communication 151 can not be recreated, and the privacy of the communication is maintained.

Upon detecting a first context similar to a first key term in the vocabulary 560, the first listening module 721 sends the first key term of the vocabulary 560 to the logic module 770 over the network 750. Using the detected first key term of the vocabulary 560, the logic module 770 searches an index 780 of content 770 (as described in reference to FIGS. 2-6) to find a first content relating to the first context of the first communication 151. As described above, in some embodiments, the index 780 stores only the link or address location of the first content. In this case, the logic module 770 follows the link stored on the index 780 to access the first content located, for example, on the content server 760. Once the first content is located, the logic module 770 downloads the first content data file from the content server 760. Thereafter, the logic module 770 sends the first content data file to the first user 711. In some embodiments, the first content is presented in a manner that does not disturb any real time communication occurring between users.

In other embodiments, the logic module 770 sends only a link to the location of the first content to the first user 711 instead of sending the first content data file. In this embodiment, the first user 711 accesses the content server 760 to download and/or view the first content. And yet, in other embodiments where the index 780 stores the first content data file, the logic module 770 directs the index 780 to send the first content directly to the first user 711.

One skilled in the art may configure the system 700 differently than that shown in FIG. 7, depending on the application. For example, it may be advantageous to couple the index 780 directly to the logic module 770 for quick access. Additionally, one may configure the system 700 such that the content server 760 is directly coupled to the index 780 and/or the logic module 770. Furthermore, in some embodiments, the logic module 770, the content server 760 and/or the index 780 are modules of the same appliance. Therefore, the configurations described above are only examples and should not be read as limiting.

In some embodiments, the vocabulary 560 accessed by the first user 711 and the second user 712 are similar. However, in some embodiments, it may be up to the users when the vocabulary 560 is updated, and therefore, the vocabulary 560 accessed by each first and second user 711, 712 may be different. When both the first and second listening modules 721, 722 access the same vocabulary 560, each listening module recognizes or detects the same first context in the first communication 151. Therefore, the logic module 770 may be configured to send both the first and second user 711, 712 the first content relating to the first communication 151. In other embodiments, the logic module 770 may be configured to send the first content to only one of the first or second user 711, 712. It would then be left up to one of the first or second user 711, 712 to share the first content with the other participant of the first communication 151.

In the above example, there may be an embodiment where the logic module 770 sends different content to the first and second user 711, 712. This may occur where the logic module 770, or another module, is tracking the content having been presented to the first and second user 711, 712. For example, in one embodiment the first user 711 has previously been presented the first content from the logic module 770 as relating to a context analogous to the first context in a previous communication. However, the second user 712 has not previously been presented this particular first content. In this embodiment, the logic module 770 will send a second content to the first user 711 rather than sending the first content for a second time. Additionally, this tracked content may be used to provide the first and/or second user 711, 712 a list of content previously presented.

Also shown in FIG. 7, is the first user 711 generating a second communication 152 with the third user 713. In this embodiment, the third user 713 is not configured with a listening module. However, the first listening module 721 of the first user 711 is configured to listen to both the first and second communication 152. This means that the first listening module 721 on the first user 711 is able to detect the use of a first and/or second key term from the vocabulary 560. Therefore, the first listening module 721 is able to detect a first context of the first communication 151 and/or a second context of the second communication 152.

In some embodiments, the system 700 does not automatically send content related to the second communication 152 to the third user 713. However, the first user 711 is able to share the first and/or second content having been presented with a co-participant of the conversation, e.g. the third user 713.

In one embodiment, the content is shared by having the logic module 770 first capture the contact information (e.g., identification and location), of the third user 713 from a contact information database of the first user 711. The logic module 770 then uses this contact information to present the first content and a client 490 to the third user 713, as described in reference to FIG. 4. In some embodiments, the client 490 sent to the third user 713 comprises a content presenter 140, viewing apparatus and/or a listening module 120 to be installed on the third user's 713 communication appliance. Once the third user 713 has the client 490, the third user 713 will be able to provide feedback of the first content also.

Referring now to FIGS. 1-7, the system 700, for example, in some embodiments is implemented imperceptibly or peripherally to the first and second communication 151, 152. The system listens for the first and second context of the first and second communication 151, 152 without interrupting the first and second communication 151, 152. In some embodiments, the first and second context are logged. However, the communication 150 can not be recreated from these logs and the first and second communication 151, 152 are not recorded or stored. Thus, the communication 150 remains private to those generating the communication.

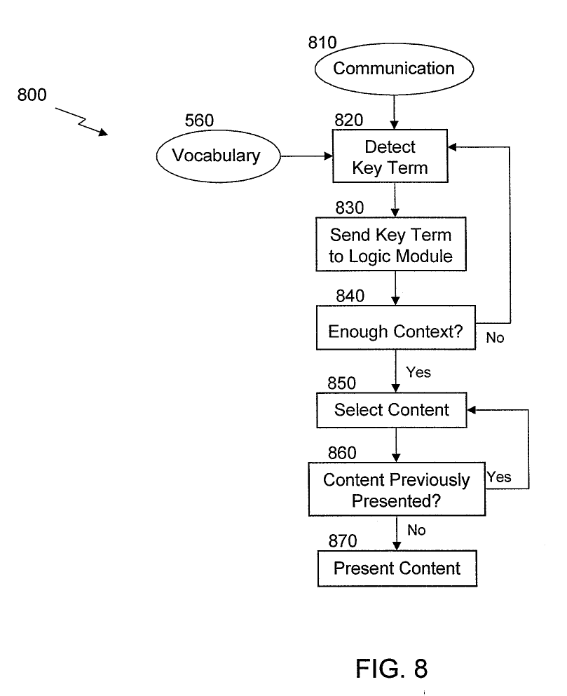

Referring next to FIG. 8, shown is an operation of the embodiments described in reference FIGS. 1-7 also. The system 800 listens 810 to a first communication 151 and detects 820 a first key term from the vocabulary 560. This first key term 830 is sent to a logic module (e.g., 770). The logic module 770 combines the first key term with previously detected key terms to determine 840 if there is enough first context present in the first communication 151 to present related content. If it is determined 840 that there is not enough context present, then the system 800 will return to listening to the communication 150 and to detecting 820 key terms from the vocabulary 560 in the first communication 151. If the logic module 770 determines 840 there is enough context, the system will select the first content related to the context of the first communication 151.

Additionally, the logic module 770 may track which content is presented to the user of the system. If the content selected has previously been presented 860 as related to a previous communication, then the system will return to selecting 850 alternative content related to the new communication. If the content has not previously been presented 860, then the system 800 will present 870 the content to the user of the system 800. The system 800 continues this process throughout the communication until the user decides to disable the system 800.

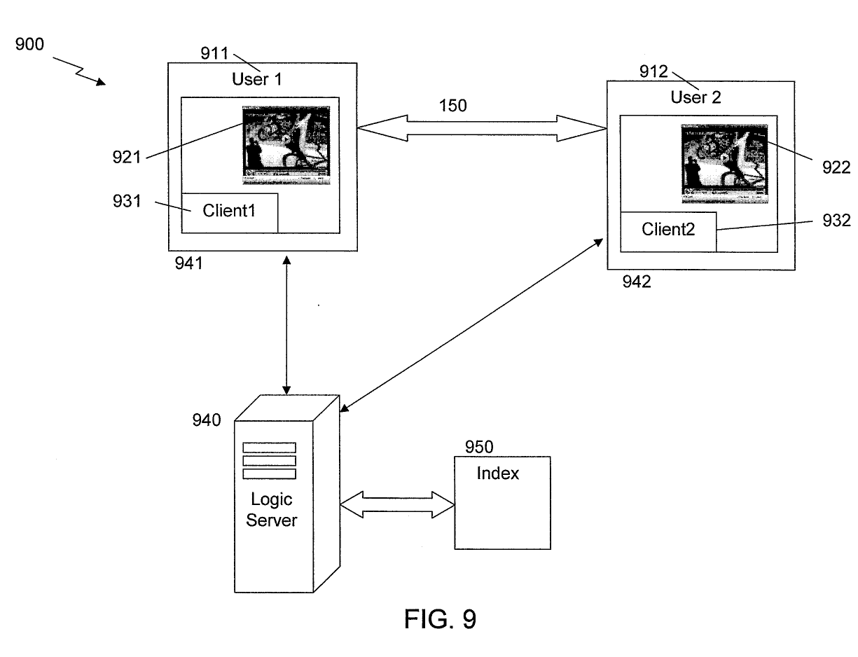

Referring next to FIG. 9, shown is a first user 911, a communication appliance 941, a first client 931, and a first viewing apparatus 921, a logic server 940 and an index 950. Also shown is a second user 912, a second communication appliance 942, a second client 932, and a second viewing apparatus 922, The first user 911 is in communication with a second user 912, wherein each first and second user 911, 912 are using a first and second communication appliance 941, 942 coupled together via a wire or wireless bus or network (not shown). The first user 911 is configured with a first viewing apparatus 921 and a first client 931. The second user 912 is configured with a second viewing apparatus 922 and a second client 932. Both the first and second user 911, 912 are in communication with the logic server 940 via a wire or wireless bus or network. The logic server 940 is coupled to the index 950.

All of the description below in reference to the first user 911, first communication appliance 941, first client 931, and first viewing apparatus 921, also applies to the second user 912, second communication appliance 942, second client 932, and second viewing apparatus 922, and any other additional users in the system.

The first client 931 may be considered a plugin, or a program that is added to the first communication appliance 941 of the first user 911 to assist in presenting content relating to a real time communication. Typically, the first client 931 is downloaded from a server onto the first communication appliance 941, such as a PC or a mobile phone. The first client 931 may be configured to work with specific or multiple types of Operating Systems (OS).

In some embodiments, the first viewing apparatus 921 is part of the first client 931. Alternatively, the first viewing apparatus 921 may be separate, and/or pre-installed onto the first communication appliance 941. Additionally, the first client 931 may include a listening module 120, searching module 130, a content presenter 140 and/or an index 220. Once the first client 931 is downloaded, the client begins to listen to communications generated by or involving the first user 911, and the system 900 is then able to present content related to the communications.

The first client 931 may be configured completely on software that runs on a computer (i.e. a personal computer or telephone), or the first client 931 may be configured in hardware installed on the first communication appliance 941. Additionally, the first client 931 may be a combination of both hardware and software. The first client 931 may also include the vocabulary 560 describe in FIG. 5.

In some embodiments, the first client 931 is configured to intercept the communication 150 being sent to either the first or second communication appliance 941, 942, and analyze the communication for a context in a manner that doing so is at least imperceptible to the users. Additionally, the first client 931 intercepts the communication 150 without recording the communication 150, such that the communication 150 remains private between the users. The first client 931, in some embodiments, is also configured to insert text or command strings into the communication 150 that is imperceptible to the users. In other embodiments, the first client 931 is configured to translate multiple types of communication protocols output by the first communication appliance 941 into a general format implemented by the present embodiments.

The first client 931 may also be configured bring up the first viewing apparatus 921 for the first user 911 to view the presented content. In one embodiment, the first viewing apparatus 921 will automatically start playing the content. In other embodiments, the first viewing apparatus 921 provides the first user 911 the option to choose to watch it.

In some embodiments, the logic server 940 is configured with a searching module, a content presenter and/or a modifying module (not shown). The logic server 940 is configured to search the index 950 for content relating to the context of the communications between the first and second users 911, 912. The logic server 940 is further configured to present the content to the first and second users 911, 912 in a format readable by the first and second viewing apparatus 921, 922. The logic server 940 may also be configured to track the content having been presented to the first and second users 911, 912. The logic server 940 is further configured to receive feedback regarding the content having been presented, and in some embodiments, modify the index 950 according to the feedback received.

The system 900 shown in FIG. 9 functions similar to the other embodiments previously described. The first and second users 911, 912 are generating a communication 150 using the first and second communication appliance 941, 942 respectively. The first and/or second client 931, 932 listens to the communication 150, and detects a context. The first and/or second client 931, 932 sends the context to the logic server 940. The logic server 940 searches the index 950 of content. The logic server 940 selects a content relating to the context of the communication 150, and presents the content to the first and/or second client 931, 932.

The first and/or second client 931, 932 presents the content to the first and/or second user 911, 912 in the first and/or second viewing apparatus 921, 922. The first and/or second user 911, 912 may share the content with other users, as described above, and may send feedback regarding the content to the logic server 940. The logic server 940 will initiate a sharing of the content with other users, and will modify the index 950 according to the feedback having been received.

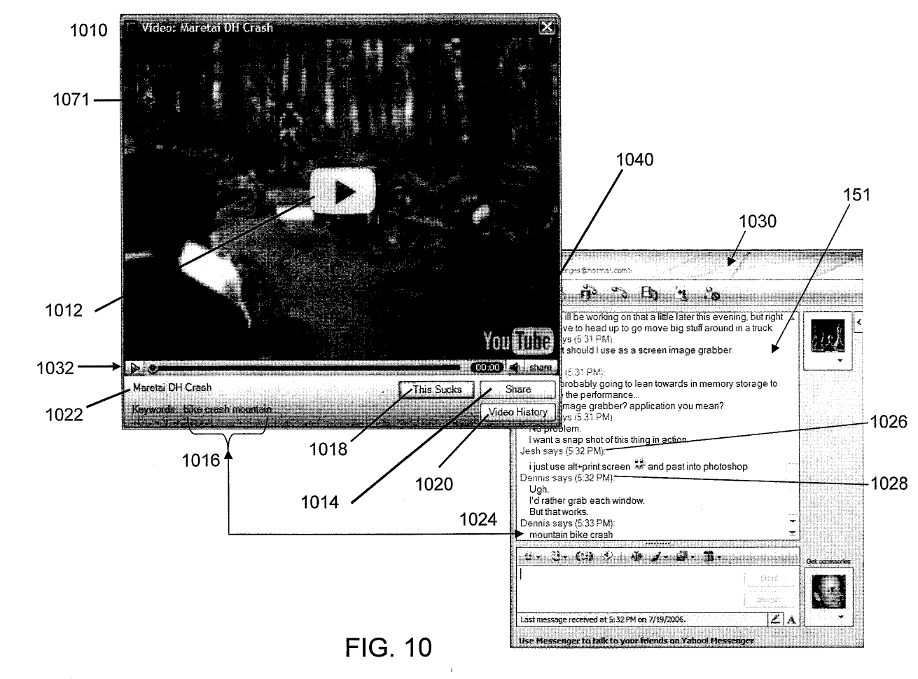

Referring next to FIG. 10, shown is an implementation of the embodiment shown in FIG. 9 comprising a first content 1071 and a viewing apparatus 1010 interface comprising control button 1012, a share option 1014, a negative feedback option 1018, a video history option 1020, a display 1016 for the vocabulary associated with the first content 1071, a title of the content 1032 and a content source label 1040. Also shown, is a first communication 151, an IM tool 1030, a participant 1026, a co-participant 1028, and a discussion 1024. In some embodiments, a content source control buttons 1032 are provided.

The viewing apparatus 1010 and the IM tool 1030 are software interfaces installed on a communication appliance of the participant 1026. The IM tool 1030 is the display portion of an IM apparatus used to communicate to the co-participant in real time using typed text. The viewing apparatus 1010 is a software tool used to present content, such as a video file or an image. The viewing apparatus 1010 comprises the control button 1012 for the participant to control the playing of the content. The viewing apparatus 1010 also comprises the share button 1014 for the participant to share the content with other people, the negative feedback option 1018, to send feedback regarding the participant's opinion of the content, and the video history option 1020 to view a listing of presented content. The viewing apparatus 1010 and the IM tool 1030 are in communication with a client (not shown) used to present content relating to a communication.

The first communication 151, shown in the IM tool, is an IM conversation being generated between the participant 1026 and the co-participant 1028. The client, as described in reference to FIG. 9, is capable of listening to real time communications generated by various types of the IM tool 1030. For example, the participant 1026 and co-participant 1028 may be using an IM tool 1030 such as Yahoo!™ Messenger, AOL™ Instant Messenger, Window Messenger Live™, Google Talk, or any other IM tool 1030 available for communicating with another participant over a network.

Not shown in FIG. 10 is the client comprising a listening module 120 and content presenter 140 installed on the communication appliance of the participant 1026 and/or the co-participant 1028, a vocabulary 560 accessible by the listening module 120, and a searching module 130 installed on a logic server 940 coupled to the communication appliance of the participant 1026 or the co-participant 1028.

The listening module 120 listens to the first communication 151 for a context using a vocabulary 560 (as describe in reference to FIG. 5). FIG. 10 shows the co-participant 1028 typed text of a discussion 1024 on a “mountain bike crash”. The listening module 120 recognizes this phrase as part of the vocabulary 560 and sends this phrase, or context of the first communication 151, to the searching module 130. The searching module 130 searches for content relating to the context, “mountain bike crash”, of the discussion 1024. The searching module 130 selects a first content 1071, such as a video of a bicycle crash, and sends the address location or link of the first content 1071 to the content presenter 140.

In some embodiments, the content presenter 140 queues up the first content 1071 to be shown on the viewing apparatus 1010. The user then controls the viewing of the first content 1071 by using the control button 1012 on the viewing apparatus 1010. For example, the control button 1012 may be a play button, and/or additional control features such as stop, rewind and volume control may be available. Additionally, the content source's control buttons 1032 may be used to control the viewing of the content.

The viewing apparatus 1010 provides the participant 1026 with the title of the content 1022 and the display 1016 that shows the “tags”, or vocabulary, related to the selected first content 1071. The display 1016 may be used by the participant to help decide on viewing the content or not. If the participant 1026 is interested in seeing the first content 1071, clicking on the play option in the control button 1012 will activate the viewing of the video of the first content 1071.

In other embodiments, the searching module 130 selects an “advertainment” to present to the participant 1026. An advertainment is an advertisement video, document, link, website, audio clip or other marketing material that is entertaining to view. The advertainment presented to the participant 1026 is selected for relating to the context, or the discussion 1024, of the first communication 151.

In some embodiments, the advertainment is presented to the participant 1026 in a manner for automatic viewing or playing of the first content 1071 (e.g. the participant 1026 does not need to click on or select the play option in the control button 1012). However, in some embodiments, even after automatic viewing, the participant 1026 will still be able to provide feedback of the first content 1071. This allows for a modification of the system if the advertainment did not relate to the discussion 1024 of the first communication 151. Additionally, it may provide feedback on the quality of the advertainment, and whether or not it is “entertaining” to viewers such as the participant 1026.

Content other than advertainments may also be presented in an automatic viewing manner depending on the application. For example, the application may allow the participant 1026 to modify the playback configuration depending on his requirements, to always automatically play the presented content.

Shown in the embodiment of FIG. 10, is the display 1016 of the terms “bike crash mountain” associated with the first content 1071 selected for presentation. In some embodiments, these terms were extracted from the content tag or file name, for example, by the harvesting module 550 as described in reference to FIG. 5. As described above, a first content source 510 typically stores the first content 1071 with a tag or file name. This tag or file name is extracted and used by the harvesting module 550 to build a vocabulary 560. This tag may be edited by the harvesting module 550 for presentation to a participant 1026, and the edited and/or original version of the tag or tags may be stored with the first content 1071 in the index 540.

As shown in FIG. 10, the system recognized the words “mountain bike crash” and selects the first content 1071 to present. In some embodiments, the searching module 130 selected the first content 1071 because it was ranked highest in the index 540 and/or because it most relates to a “mountain bike crash” out of all the content in the index 540. This first content 1071 was found from the content source called YouTube™, as seen by the content source label 1040.

After viewing at least part of the video, the participant 1026 can provide feedback to the system, or share the first content 1071 with the co-participant 1028. If the participant 1026 thinks the video was not relevant to the context 1024 of the first communication 151, or if the participant 1026 did not like the quality of the first content 1071, the participant 1026 will select the negative feedback option 1018 (e.g. the “This Sucks” option). In some embodiments, there is a positive feedback option, e.g. an “I Like It” option, for the participant to select if the participant 1026 liked the first content 1071.

The participant 1026 may share the first content 1071 by selecting the share option 1014. In some embodiments, selecting the share option 1014 provides positive feedback about the first content 1071. When the participant 1026 chooses to share the first content 1071, the first content 1071 is sent to the co-participant 1028. In some embodiments, choosing to share the first content 1071 may also initiate a sharing of the first content 1071 with all of the contacts (or buddies, described in more detail below) of the participant 1026. In other embodiments, the participant 1026 may choose more than one recipient with whom to share the first content 1071.

Additionally, the viewing apparatus provides a video history option 1020 for the participant 1026 to view the content previously presented. The viewing apparatus 1010 may track which content has been presented, or another module such as the logic module described in reference to FIG. 7 may track the presented content. This option may allow the participant 1026 to navigate back to the content previously presented for additional viewing and/or sharing with other users. The video history option 1020 is not limited to videos, and may also list any type of content previously presented to the user including documents, audio files, websites, and/or the like.

The interfaces described above are examples of various interfaces used to present content to the user. However, this technology may be implemented in various embodiments, and one skilled in the art may additionally or alternatively include user interface features not described herein.

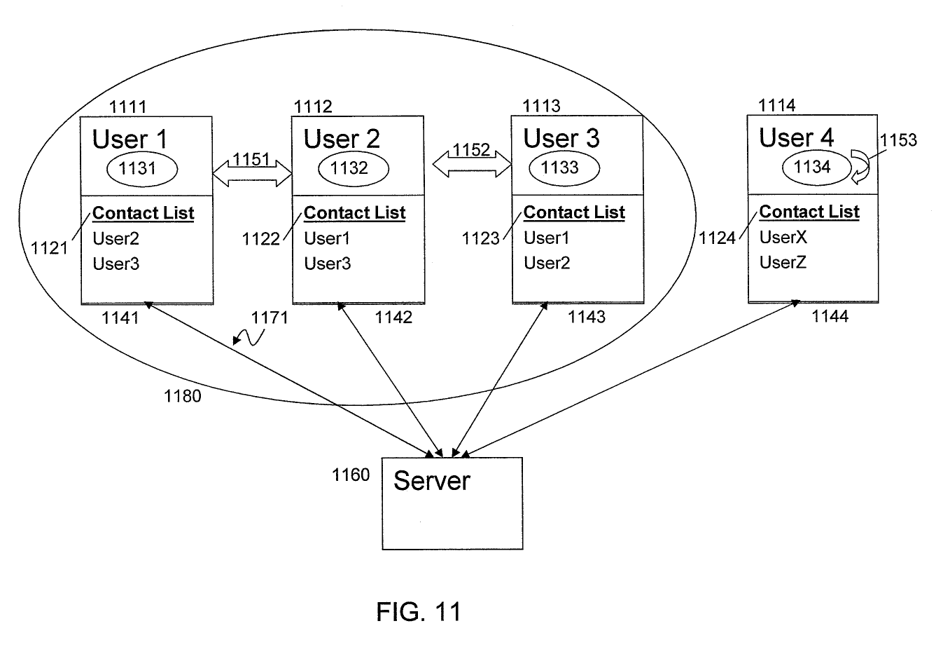

Referring next to FIG. 11, shown is a first, second, third and fourth user 1111, 1112, 1113, 1114, a first, second, third and fourth communication appliance 1141, 1142, 1143, 1144 and a first, second, third and fourth communication generator 1131, 1132, 1133, 1134, a first, second, third and fourth contact list 1121, 1122, 1123, 1124, a social network 1180, and a server 1160.

The first, second, third and fourth communication appliance 1141, 1142, 1143, 1144 are coupled to the server 1160 over a wire or wireless bus or network, and is configured to communicate with one or more other users. At least the first, second, and third communication generator 1131, 1132, 1133 are real time communication apparatus installed on the first, second and third communication appliance 1141, 1142, 1143 used to communicate with the other users over a network, such as the internet. The fourth communication generator 1134 is configured to generate communication such as a text document.

The server 1160 is configured to present content to the users relating to the communications generated by the first, second, third and fourth communication generators 1131, 1132, 1133, 1134. In some embodiments, the server 1160 comprises a listening module 120, a searching module 130 and a content presenter 140 (all not shown). The server 1160 is configured to listen to first second and third communication 1151, 1152, 1153 being generated by the first, second, third and fourth users 1111, 1112, 1113, 1114. The server 1160 is configured to present content relating to the communications.

The first, second, third and fourth contact list 1121, 1122, 1123, 1124 are associated with each of the first, second, third and fourth user 1111, 1112, 1113, 1114 respectively. The contact lists, comprise the identification of other users and/or communication appliances configured to converse over the network (e.g., an IM tool with a buddy list). The server 1160 is configured to capture the usernames and identification information of the first, second, third and fourth user 1111, 1112, 1113, 1114 from their communication appliance and/or their communication generator (e.g., the IM tool and their contacts' usernames).

The first, second and third contact lists 1121, 1122, 1123 are used to build the social network 1180. For example, the social network is may be a network of IM buddies. The fourth user 1114 is not included in this social network 1180 because he is not listed on any of the first, second or third contact lists 1121, 1122, 1123. As the users 1111, 1112, 1113 view and rate content presented by the server 1160, these actions will directly affect which content is presented to their buddies in the social network 1180.

As described in reference to FIGS. 1-10, the feedback provided by users influence what is presented to other general users of the system. In some embodiments, a separate index or ranking system may be used for a social network 1180. Therefore, feedback provided by someone in a social network 1180 will weigh heavier on modifying the ranking for the content shown within the social network 1180. Additionally, the social network 1180 may be used for submissions of content to be shared with others within the social network 1180.

For example, the first user 1111 is presented a first content (not shown) relating to the first communication 1151. Then, the first user 1111 decides, after viewing it, that he likes the first content. The first user 1111 then provides positive feedback to the server 1160 and/or shares the first content with the second user 1112. Next, the fourth user 1114 is also presented the same first content regarding a separate communication being generated out of the fourth communication generator 1144. However, the fourth user 1114 provides negative feedback about the first content.

Subsequently, the second and third users 1112, 1113 generate a second communication 1152 similar to the first communication 1151. In some embodiments, the server 1160 will still present the same first content to the second and third users 1112, 1113, regardless of the negative feedback from the fourth user 1114. This is because, in some embodiments, the feedback from the first user 1111 will more directly influence what other users in the social network 1180 are presented during future communications, than will the feedback of the fourth user 1114.

Furthermore, in some embodiments, the first, second, and third users 1111, 1112, 1113 may be used as a content source, wherein only those buddies in the social network 1180 can obtain content from the other users in the social network 1180. For example, the social network 1180 can be used for submitting a second content for presenting to the social network 1180, and influencing a future presenting of the first content to at least or more users in the social network 1180.

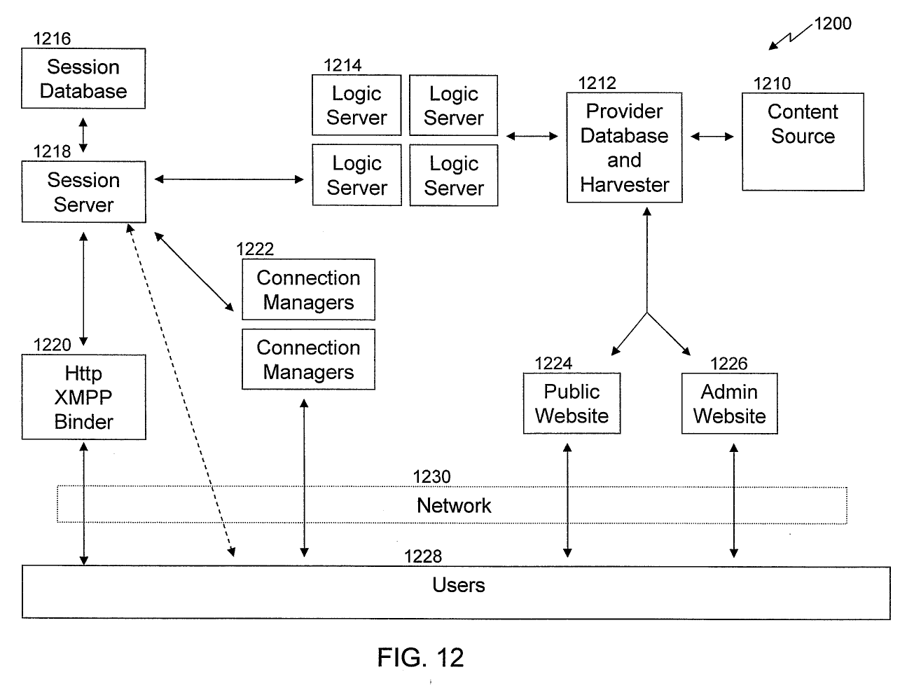

Referring next to FIG. 12, shown is a content source 1210, a provider database and harvester 1212, logic servers 1214, a session server 1218, a session database 1216, connection managers 1222, a Hypertext Transfer Protocol (HTTP) Extensible Messaging and Presence Protocol (XMPP) Binder 1220, a public website 1224, an administrative website 1226, a network 1230 and users 1228.

In the present embodiment, the provider database and harvester 1212 is coupled to a content source 1210, the logic servers 1214, a public website 1224 and an administrative website 1226. The logic server 1214 is additionally coupled to a session server 1218. The session server 1218 is additionally in communication with a session database 1216, and in some embodiments, the HTTP XMPP Binder 1220 and/or the connection managers 1222. The users 1228 are coupled to a network 1230, and are configured to communicate over the network 1230 with the session server 1218, and in some embodiments this communication is via the HTTP SMPP Binder 1220 and/or the connection managers 1222. The users 1228 are also in communication with the public website 1224 and the administrative website 1226.

The session server 1218 may be used to handle sessions. A session, for example, is the communications over a network used during the period of listening and presenting content relating to a communication. The session server 1218 is used for, for example, all Transmission Control Protocol (TCP) connections, to authorize user's login names and passwords, and to route all messages to one of the logic servers 1214. The session server 1218 initiates a session when a user 1228 indicates he would like the system 1200 to present content relating to communication he is generating (e.g. activating the client on his PC described in reference to FIG. 9).

The session server 1218 may be implemented with a server such as a Wildfire Root Server that is configured to handle, for example, communication protocols used in an IM conversation, such as TCP, XMPP, and/or the Jabber protocol. Such servers are typically configured to handle a certain amount of users, (e.g. 5000 users). Therefore, in some embodiments, multiple connection managers 1222 are implemented to expand the capacity of the session server.

The users 1228 may access the public website 1224 to download the client used in presenting content relating to a communication. The users 1228 may also access the administrative website 1226 for configuration features available to the client. The provider database and harvester 1212 is configured to harvest the content (as described in reference to FIG. 5) from the content source 1210, and provide the content to the logic servers 1214.

The HTTP XMPP Binder 1220 is configured to bind communications to a transport layer of HTTP instead of TCP. This is done because the binding of XMPP to TCP is not always feasible due to client runtime environments and/or network constraints. In some embodiments, the HTTP XMPP Binder 1220 is implemented to allow a client (931 as described in reference to FIG. 9) to bypass firewalls which may be blocking the standard port for XMPP. In the event that the client 931 is unable to communicate to the logic servers 1214 over the standard port with a TCP stream, the client 931 will attempt to connect to the HTTP XMPP Binder 1220 using standard HTTP requests to retrieve the appropriate data from the logic servers 1214. This configuration appears to be a standard web page request to firewalls blocking the users 1228 network 1230 activity. Thus, the client 931 is able to bypass the firewall and access the logic servers 1214.

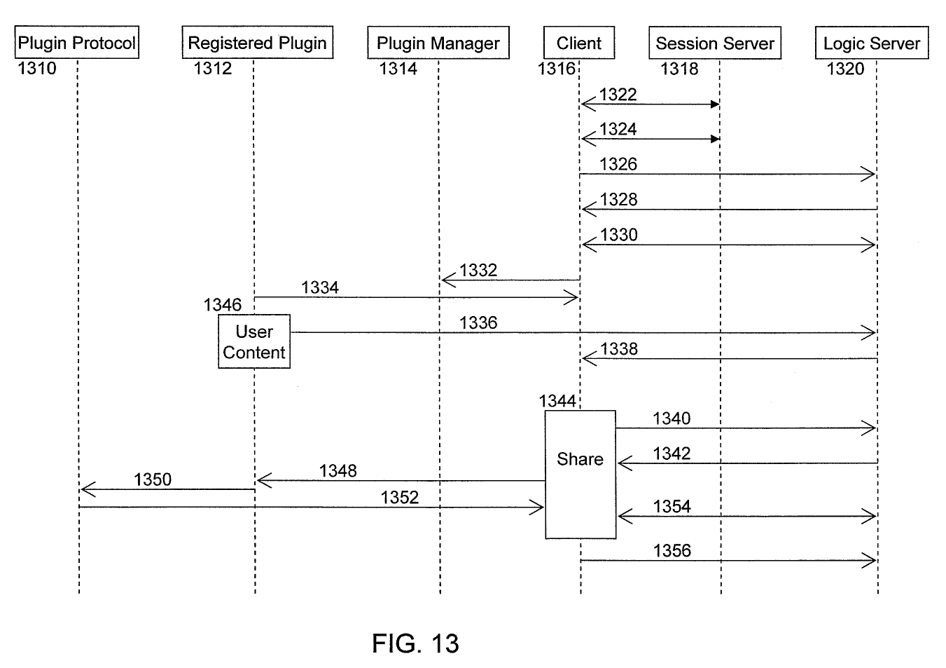

Referring next to FIG. 13, shown is a first logic server 1320, a session server 1318, a client 1316, a plugin manager 1314, a registered plugin, a plugin protocol 1310, user content 1346 and a share module 1344.

The first logic server 1320 is in communication with the session server 1318, the client 1316 (installed on a user's communication equipment), the user content 1346, and the share module 1344. The session server 1318 is also in communication with the client 1316. The client is additionally in communication with the plugin manager 1314, the registered plugin 1312, the share module 1344 and the plugin protocol 1310. The registered plugin 1312 is also in communication with the user content 1346 and the plugin protocol 1310. The plugin protocol is further in communication with the share module 1344.

In operation, a client 1316 initiates a session with the session server 1318 by first negotiating credentials 1322 of the user. The user's credentials are, for example, a username and password. If the initiation is not the first time the user has used the content providing system, then the client 1316 can connect using an authentication protocol and/or tool, such as, the Transport Layer Security (TLS) Authentication, to encrypt the credentials. The TLS Authentication is a protocol used to provide a way to secure an application protocol from tampering and eavesdropping. This type of encryption tool and other tools are often used with Jabber servers such as Wildfire describe above in reference to FIG. 12.

A first time initiation by a client 1316 requires the initial connection and setup with the content providing system when negotiating credentials 1322. For example, the client 1316 generates a new username and password from the user's Globally Unique Identifier (GUID), and stores them in a database. Next, the user connects anonymously to the session server 1318 and registers the username and password using an in-band registration to create an account with the generated username and password. In some embodiments, the client is configured to allow the user to generate a username and password that is easily remembered by the user, and also allows the username and password to be persistent across many machines or installations.

After initiating a session, the client 1316 retrieves the attached items 1324 from the session server 1318. Then the client 1316 sends 1326 a command (e.g. “disco#items”) to the session server 1318 to get the version and information for every logic server 1214 listed on the session server 1318. The client 1316 then filters the list for devices with the correct logic server 1214 names, and sends a message to these logic servers 1214 (e.g. “dicso#info” and “disco#version”). The first logic server 1320 to respond with the proper credentials is selected 1328 by the client 1316 for this session.

In some embodiments, the process of connecting to, and selecting, the first logic server 1320 is a natural load balancer. For example, the session server 1218 in FIG. 12 allows the connection of multiple external components (e.g. logic server 1214) at the same time via component protocol. When the client 1316 sends 1326 a command to retrieve the disco#version and disco#info from each logic server 1214, the logic server 1214 with the lightest load will respond the fastest. The client 1316 will choose the first logic server 1320 with the fastest response, and thus, the lightest load.

Next, the client 1316 retrieves the master tag list 1330. The client 1316 then opens 1332 an Inter-process communication (IPC) channel with the plugin manager 1314. In some embodiments, a technology built into a Microsoft™ Net framework called Remoting is used for the IPC channel. The registered plugin 1312 registers 1334 through the IPC channel. The registered plugin 1312 generates a communication such as the user content 1346, and submits tags 1336 to the first logic server 1320. The first logic server 1320 selects content, such as a video, to present, and pushes the video 1338 to the client 1316.

A share module 1344 on the client 1316 sends 1340 share details for each recipient to the first logic server 1320. A share detail may include identification information about a contact that the user would like to share the presented content with. The first logic server 1320 responds 1342 to the request to share details and includes the share module's GUID. The share module 1344 sends 1348 a share message to the registered plugin 1312. The registered plugin 1312 sends 1350 a share message to the contact through the plugin protocol 1310. If the sending protocol supports sending shares, then the share is received by the recipient and the share module receives 1352 the share details. The client 1316 may then provide 1356 feedback to the first logic server 1320.

In some embodiments, the client 1316 is configured to be as thin as possible while still maintaining the ability to retrieve messages from the IM stream, insert messages into the IM stream, play videos, submit feedback from the user, and share the content with other users. The client 1316 may be developed, for example, on a software platform such as the Microsoft™ .Net 2.0 Framework. In some embodiments, the client 1316 has separate logic for the user interface.

A user may receive content upon at least three different events. For example, a first event is when content is sent to the user because a context was detected in a communication generated by the user. A second event is when content is shared by one user with another. A third event is when content was shared with a user who was not logged in to the system and the system had queued the content for the user to view after logging in.

For the first type of event, when a detection of a context in a conversation by the first logic server 1320 occurs, (also described in reference to FIGS. 1-10) the first logic server 1320 sends the content to the client 1316, and the client 1316 loads the content into a viewing apparatus. In some embodiments, if the viewing apparatus is a window not currently visible (e.g., not activated yet or minimized to a menu bar), then a popup window is presented informing the user of the availability of the content.

For the second type of event, where a first user shares content with a second user, selecting the share option will create a text message that is sent to the second user via an IM tool, for example. The client 1316 on the second user's communication appliance will parse out the share command from the IM stream, and notify the second user of the content that was shared with him. In some embodiments, the content is not automatically loaded onto the second user's viewing apparatus. The second user must accept the viewing of the content before it is loaded into the viewing apparatus.

In the case of the third type of event, where a user logs on to the system and there is content queued up for his viewing, the client 1316 may act similarly to that described in the first case above. Or, for example, a user has installed a client 1316 onto his PC, but does not have it running. In this case, a popup window may appear to tell him that content is available for viewing. However, in all types of events, the interface for the user may be the same as the first or second case described above, or alternatively, some interfaces may be different. Additionally, the client 1316 may present the content to the user by using a semi-transparent banner sliding over a portion of the content, for example.

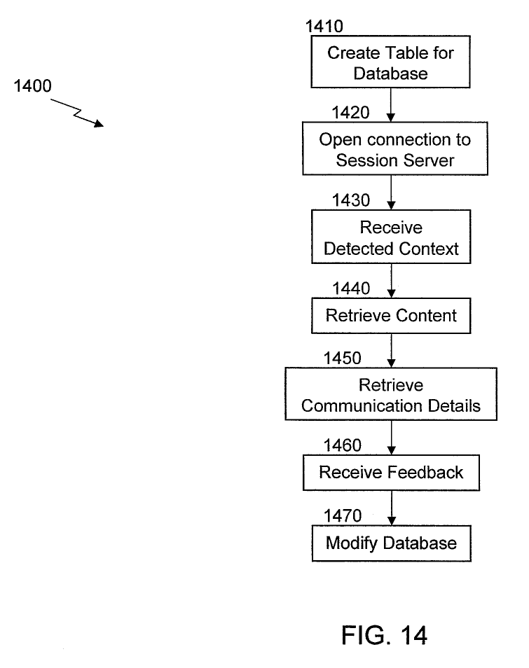

Referring next FIG. 14, shown is an operation of the first logic server 1320 of FIG. 13. Some of the responsibilities of the first logic server 1320 include recording the context that the client 1316 detected, logging these detections, and selecting and presenting content to the client 1316 that is relevant to the detected context. The first logic server 1320 or the harvesting module 550 starts with indexing 1410, in an index, the content, by building tables with elements such as the following:

```
videos {
  id int,
  play_weight int,
  play_weight_modifier int
}
tags {
  id int,
  name string,
  weight int,
  weight_modifier int
}
video_tags {
video_id int,
weight_modifier int
}
users {
  id int,
  username string
}
user_video_history {
  user_id int,
  video_id int
}
user_tags_pending {
  user_id int,
  tag_id int
}
```

In some embodiments, the database is written in MySQL®, an open source database server, data warehouse and protocol.

Next, the first logic server 1320 will then copy the pertinent data from the database. For example:

```
Videos:
  SELECT video_id as id, play_weight, play_weight_modifier FROM
ut_videos WHERE play=1 and status_id=3
Tags:
  SELECT tag_id as id, name weight, weight_modifier FROM ut_tags
WHERE watch=1
Video_tags:
  SELECT video_id, tag_id, weight_modifier FROM ut_video_tags.
```

Next, the first logic server 1320 opens 1420 the connection to the session server 1318, and waits for incoming connections. The first logic server 1320 receives 1430 the detected context, and records the context in the table in the database. The first logic server 1320 then retrieves 1440 content relating the detected context. The first logic server 1320 retrieves 1450 the communication details, such as, what vocabulary was used in the communication and the identification of all participants involved in the communication. The first logic server 1320 then populates the table with the content details and the communication details.

Once the user has viewed the content, the first logic server 1320, in some embodiments, receives 1460 feedback from the user about the content. The feedback interface is described in further detail in reference to FIG. 10. Once feedback is submitted, the first logic server 1320 modifies 1470, and/or updates, the index. The feedback received is also used by the first logic server 1320 to modify the content ranking as described above.

For example, a co-participant 1028 of a first communication 151 types in to the IM tool 1030: “I crashed so hard on my mountain bike today“. The listening module detects the terms ‘mountain’, ‘bike’, and ‘crashed’ that match the vocabulary 560. The logic server 1214 searches for content relating to this context, and returns the video “Crazy Crash”, and sends the video to the content presenter. The user then chooses to play the video, and likes it so much that he decides to share the video with a buddy. The logic server then updates the ut_videos table:

| | | | | | (af- |
|---|---|---|---|---|---|
| Id | Name | Play | Play_weight | Play_weight_modifier(before) | ter) |
| 0 | Crazy | True | 24 | 0 | −1 |
| | Crash | | | | |

With a modifier of −1, the “Crazy Crash” video now has a sum play weight of 23, lower than before the share. This means, that in this embodiment, that the logic server is more likely to choose this video than it was before, and therefore will be played more often across the whole system.

In some embodiments, an element, like the “Play_Weight” above, is used as a content ranking. The logic server may choose only content whose content ranking is above or below a predefined threshold, depending on how the algorithm works. For example, the Play_Weight is assigned a number, and this number is reduced every time positive feedback or a sharing of the content has occurred. Therefore, the logic server may only choose content with a Play_Weight below 25. This Play_weight element may also dynamically change depending on the context of the communication and how well it relates to the context.

Next, the logic server updates the vocabulary used to detect context by updating the ut_tags table:

| Id | Name | Watch | Weight | Weight_modifier (before) | (after) |
|---|---|---|---|---|---|
| 0 | Funny | True | 10 | 0 | 0 |
| 1 | Mountian | True | 12 | 0 | 1 |
| 2 | Bike | True | 8 | 0 | 1 |
| 3 | Crashed | True | 10 | 0 | 1 |

This ut_tags table is updated because keywords detected in the communication above (e.g., mountain, bike, and crashed) resulted in selecting content appreciated by the user (as shown by the feedback received). Thus, it is helpful to increase the value of these words so that they are more likely detected in future communications. The “weight” of the term may also be considered a key term ranking that is modified according to feedback received by the system.

Next, the logic server updates the index for the vocabulary associated with the content by updating the ut_video_tags table:

| Video_id | Tag_id | Weight_modifier (before) | (after) |
|---|---|---|---|
| 0 | 0 | 0 | 0 |
| 0 | 1 | 0 | 2 |
| 0 | 2 | 0 | 2 |
| 0 | 3 | 0 | 2 |

This update increases the value for the vocabulary associated with the content. For example, the video “Crazy Crash”, the terms ‘mountain’, ‘bike’ and ‘crashed’ should be ranked higher as associated with the video than should the term ‘funny’. Thus, these terms are more likely to match with relevant content in future communications.

The goal of the feedback method is to improve matching the context of a communication with the content selected for presentation. There are other columns not described here, such as, ut_videos.play, ut_videos.play_weight, ut_tags.watch, and ut_tags_weight that can be manually modified by administrators to help improve content matching. This will also allow the system to present more current events and advertainments, or just remove some content. Although the above example uses a video as the content, one skilled in the art can apply the above system to other types of content as described above.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for providing a content corresponding to a real time communication comprising:
detecting a context in the real time communication;
selecting a first content relating to the context of the real time communication; and
presenting the first content concurrently with the real time communication to a participant of the real time communication.

2. The method of claim 1 further comprising:
accessing a source providing the first content and accessing the first content;
extracting a first key term from the first content having been accessed; and
using the first key term for the detecting of the context of the real time communication.

3. The method of claim 2, further comprising:
indexing, in an index, the first content having been accessed, wherein the index includes a first content ranking associated by the source to the first content.

4. The method of claim 3, further comprising:
associating, in the index, with the first content at least one of the first key term having been extracted and the first key term associated with a first key term ranking.

5. The method of claim 4, further comprising:
selecting the first content when at least one of the first content ranking is above a first threshold and the first key term ranking is above a second threshold.

6. The method of claim 3, further comprising:
receiving a first feedback of the first content from the participant in response to the first content having been presented; and
modifying the index in response to receiving the first feedback from the participant.

7. The method of claim 1, wherein the detecting the communication further comprises imperceptibly detecting the context of the real time communication while maintaining the privacy of the real time communication.

8. The method of claim 1, further comprising:
sharing the first content with a co-participant of the real time communication.

9. The method of claim 8, further comprising:
providing a client with the first content having been shared if the client is not present on a communication appliance of the co-participant.

10. The method of claim 1, further comprising:
the presenting further comprising displaying the first content to the participant in a viewing apparatus;
tracking the first content having been displayed; and
selecting a second content upon detecting the context in the real time communication after the first content has been displayed.

11. The method of claim 1, wherein the first content having been presented is an advertainment relating to the context of the real time communication.

12. The method of claim 1, further comprising:
building a social network with a plurality of members comprising at least the participant and a first contact configured to communicate with the participant, wherein the social network is used for at least one of:
modifying a content ranking of the first content, submitting a second content for presenting to the social network, and influencing a future presenting of the first content to at least one of the plurality of members in the social network.

13. A system for providing content relating to a context of a real time communication comprising:
a listening module configured for detecting the context of the real time communication;
a searching module coupled to the listening module, the searching module configured to retrieve a first content relating to the context in response to the listening module detecting the context; and
a first content presenter coupled to the searching module, wherein the searching module is configured to provide the first content to the first content presenter concurrently with the real time communication.

14. The system of claim 13, further comprising:
a harvesting module configured to access a first content source, the first content source configured to store the first content, wherein the first content source associates a first content ranking to the first content; and
an index coupled to the searching module and the harvesting module, the harvesting module configured to index, in the index, the first content and the first content ranking, wherein the first content is at least one of an address location where the first content is accessed and a data file.

15. The system of claim 14, further comprising:
the harvesting module configured to extract a first key term from the first content;
the harvesting module configured to index, in the index, the first key term and a first key term ranking;
the first content presenter configured to display the first content to a participant of the real time communication, and the first content presenter configured to receive a first feedback from the participant of the first content having been displayed; and
a modifying module coupled to the index, the modifying module configured to modify at least one of the first content ranking and the key term ranking in the index in response to receiving the first feedback.

16. The system of claim 13, further comprising:
the first content presenter configured to display the first content to a participant in the real time communication by at least one of displaying an address of a first source providing the first content, accessing the first source and opening the first content for the participant to view, and initiating the viewing of the first content upon a request by the participant.

17. The system of claim 13, further comprising:
the searching module configured to share the first content to a second content presenter of a co-participant involved in the real time communication.

18. A method for displaying content relating to a communications comprising:
indexing, in an index, a plurality of content from a source and a content ranking associated with each of the plurality of content;
selecting, from the plurality of content, a first content relating to a first context of a first communication; and
retrieving the first content from the source and presenting the first content to a first viewer concurrently with the first communication.

19. The method of claim 18, further comprising:
receiving a first feedback from the first viewer of the first content; and
modifying the index of the plurality of content in response to the first feedback having been received, wherein the first feedback reflects an opinion of the first viewer regarding at least one of a quality of the first content and a relatedness of the first content to the first context.

20. The method of claim 18, wherein the modifying the index influences the presenting of the first content during a second communication with a second context analogous to the first context.

21. The method of claim 18, further comprising:
capturing an identification of a contact of the first viewer; and
sharing the first content with the contact upon receiving a request to share the first content by the first viewer.
